(19) United States
(12) Patent Application Publication
(10) Pub. No.: US 2008/0124993 A1
(43) Pub. Date: May 29, 2008

(54) Heat and flame resistant fiber product and process for making same

(76) Inventor: Paul H. Brady, Columbus, MS (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/563,481

(22) Filed: Nov. 27, 2006

(51) Int. Cl. B32B 5/02; D04H 1/46

(52) U.S. Cl. 442/142; 28/108

(57) ABSTRACT

A lightweight (2.25 to 6 ounce per square yard) fabric mechanically bonded through needle-punching formed of fire-retardant fibers with no post-treatment. The composition of the fibers is typically 75 to 85% fire-retardant cellulose and 15 to 25% fire inhibiting modacrylic fiber with a high limited oxygen index. The cellulosic fiber in particular can be rayon or lyocell saturated with a fire-retardant agent such as diammonium phosphate. The cellulosic fiber acts as a char-former thereby creating a carbonized thermal insulator. The modacrylic is an acrylic modified fiber with additional monomers which reduce fuel value and help limit the available oxygen to the fire cycle. The modacrylic component also serves to add strength to the char-forming fiber by softening and thereby binding to the charring fibers. The fibers are blended together and homogenized into a lightweight fiber web which is stacked in staggered layers to form a low density batting. The batting is then passed through two needle-bonding machines which mechanically entangle the batting fibers to form a dense needle-punched fabric. The fabric is then slit and rolled up into usable form. No additional processes or post-treatments are necessary to impart the fire-retardancy. This material is designed to be used immediately under the outer-ticking or finished surface layer of upholstery and will protect solid materials beneath it from burning. The product is designed to comply with the Federal Regulation 16 C.F.R. 1633 and California Code TB6B603.

### BACKGROUND OF THE INVENTION

The present invention relates to a heat and flame resistant fiber product and process of making.

Because of the importance of fire prevention in the home and in businesses, standards and legislation have been established directed to improving safety and, in particular, with respect to mattresses, sheets and pillowcases as well as fabrics for covering furniture in the home and in commercial establishments. The typical method for providing fire retardation is to apply coatings to fabrics. Certain standards have already been established for fire retardant fabrics such as those covered by Federal Regulation 16 C.F.R. 1633 and California Code TB603. It is desired to produce a fire resistant fabric without the use of silicas or post-treatments of fabrics or the need for applications of coatings to the finished fabric.

### SUMMARY OF THE INVENTION

The present invention provides fire-retardant fiber products and fabrics which are lightweight and mechanically bonded through needle punching. The products of the present invention are characterized by not requiring inclusions such as silica which has been used in the past or the need for post treatment coatings applied to the finished fabric. The products of the present invention are typically formed of 70 to 90% cellulose and 10 to 30% modacrylic with a high limited oxygen index (LOI). In particular the cellulosic fabric can be rayon or lyocell saturated with a fire-retardant agent such as diammonium phosphate. The cellulosic fiber acts as a char-former thereby creating a carbonized thermal insulator. The modacrylic material is an acrylic polymer modified with additional monomers which reduce fuel value and help limit the available oxygen to the fire cycle.

The modacrylic also serves to add strength to the char-forming fiber by softening and thereby binding the charring fibers as they burn.

In carrying out the invention, the cellulose fibers saturated with the fire retardant agent and the fire inhibiting modacrylic are blended together to form a blended fiber product. The blended fibers are subjected to homogenization to produce a lightweight fiber web. This fiber web is then stacked in staggered layers to form a low density batting. After that, the batting is then passed through two or more needle-bonding machines which mechanically entangle the batting fibers to form a dense fabric. Following that, the fabric is then longitudinally slit and rolled up into two adjacent fabric rolls. No additional processes or post-treatments are necessary to impart the fire-retardant properties.

The products of the present invention can be used immediately under the outer ticking or finished surface layer of upholstery or mattresses and will protect solid materials beneath them from burning.

### BRIEF DESCRIPTION OF DRAWINGS

The present invention will be further understood with reference to the accompanying drawings; wherein:

FIG. 1 shows a schematic flow diagram for preparing the products of this invention; and,

FIG. 2 is a schematic view of a staggered stack of low density batting.

### DETAILED DESCRIPTION OF INVENTION

The particular form of cellulosic fiber which is preferred is rayon which is available from a variety of sources including Innotherm Products, LLC, a division of Hickory Springs Manufacturing Company. Rayon is a well-known material and, in the typical process of making rayon, purified cellulose is chemically converted into a soluble compound. A solution of this compound is then passed through a spinnerette to form soft filaments which are then converted or regenerated into almost pure cellulose. Because of the reconversion of the soluble compound to cellulose, rayon is frequently referred to as regenerated cellulose fiber. Several different types of rayon fibers are available in commerce today, according to the process by which the cellulose is converted to the soluble form and then regenerated as the solid fiber. Rayon fibers are wet spun which means that the filaments emerging from the spinnerette pass directly into chemical baths which solidify or precipitate or regenerate the rayon in a solid form. Viscose rayon is made by converting purified cellulose to xanthate, dissolving the xanthate in dilute caustic soda and then regenerating the cellulose from the product as it emerges from the spinnerette. Most rayon today is made by the viscose process. The process of making cellulose fiber is well known and understood in the industry as shown, for example, with reference to various Internet sources such as www.fibersource.com/f-tutor/rayon.htm.

Lyocell is another commercially available cellulose fiber that can be used for purposes of this invention. The Federal Trade Commission definition for lyocell fiber is a cellulose fiber obtained by an organic solvent spinning process where organic solvent means a mixture of organic chemicals and water and solvent spinning means dissolving and spinning without the formation of a derivative. Raw cellulose is directly dissolved in an amine oxide solvent. The solution is filtered, extruded into an aqueous bath of dilute amine oxide and coagulated into fiber form. Lyocell can be either washable or dry cleanable depending on the care label.

The product of the present invention is a lightweight fabric typically weighing from 2.25 to 6 ounces per square yard. The secondary fiber which is blended with the cellulosic component is a fire inhibiting modacrylic with a high limited oxygen index (LOI).

In preparing the rayon, the rayon is typically treated with diammonium phosphate as a flame retarding agent in a batch process. The fiber is saturated with a solution of a phosphate such as diammonium phosphate, thereby allowing the phosphate to permeate the fiber structure. The excess solution is pressed out and the fiber is then dried. The content of the diammonium phosphate within the rayon fiber is targeted to be about 12 to 17% of the total weight of the treated fiber.

While rayon is typically the preferred fiber used as the cellulosic component, lyocell can also be used in place thereof or mixed with rayon. Lyocell and rayon are the two most common forms of regenerated cellulosic fibers produced under somewhat different manufacturing techniques.

The diammonium phosphate is one of many compounds which can be used to add the fire-retardant properties to fibers. It is advantageous in that it is relatively non-toxic, containing no antimony, phosphorous, arsenic, halides or polybromodiphenyl compounds which have been used in the past. Sodium borate or sodium tetraborate (commonly known as Borax) is another non-toxic compound which can be used to obtain fire-retardant properties in an absorbent material such as fabric.

Diammonium phosphate is preferable for use as the fire-retardant because it limits the inherent fuel value of the cellulose by inhibiting the formation of levo-glucosan upon thermal decomposition of the cellulose, thereby releasing less volatile gases, and allowing the formation of nonflammable char.

The second fiber type used to prepare the lightweight fire-resistant fabric of the present invention is generically known as modacrylic. Modacrylic fiber is technically known as a manufactured fiber in which the fiber forming substance is any longer chain synthetic polymer composed of less than 85% but at least 35% by weight of acrylonitrile units (—CH₂CH[CN]—)x. Modacrylic fibers are typically made from resins that are copolymers of acrylonitrile and other materials such as vinyl chloride, vinylidene chloride or vinyl bromide. Modacrylic fibers can be either dry spun or wet spun. The low softening temperatures of modacrylic fibers allow them to be stretched, embossed and folded into special shapes. The fibers may be produced with controlled heat shrinkage capacities. When fibers of different shrinkages are mixed in the surface of a pile fabric, the application of heat develops fibers of different lengths, producing a surface that resembles natural fur. These materials are well known in the art and understood by those persons in this technology. Modacrylic fibers that can be used for purposes of the present invention are obtainable from a variety of sources such as Kaneka Corporation of Japan.

The limiting oxygen index (LOI) is an indicator of the flame retardant characteristic of a material. The higher the limiting oxygen index, the less prone a fiber is to burning. Fibers with a limiting oxygen index (LOI) of higher than about 26 are difficult to keep burning. The definition of limiting oxygen next is found in the Dictionary of Fiber and Textile Technology, Hoechst Celanese Corporation. LOI is a relative measure of flammability that is determined as follows: A sample is ignited in an oxygen/nitrogen atmosphere. The oxygen content is adjusted until the minimum required to sustain steady burning is found. The higher the value of LOI, the lower the flammability.

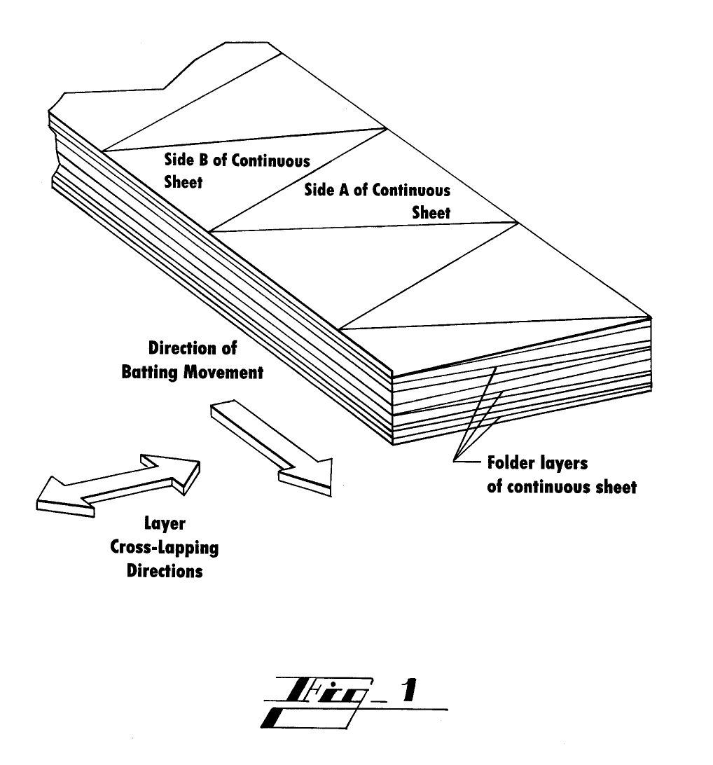

FIG. 1 shows a flow diagram of the process of the present invention. The fiber bale of cellulosic fiber impregnated with the fire retardant agent and modacrylic fiber bale: (1) are each loaded onto the bale opener (2), here each bale is opened and the fibers are deposited onto the fiber conveyor (3). The process for blending the two fibers used to make this material begins in the bale opening line (2). Each fiber is metered out by the weight percentage desired onto a moving conveyor (3) with one fiber type stacked on top of the other. The fiber mat then proceeds through three pre-opening blending devices (shown schematically as 4) that help to separate the compacted fiber clumps. The fiber in the bale form is highly compressed and will stay in compressed clump form until physically broken apart. The fibers are then sent on the fiber transport system (5) to a storage location (6) from which they are sent to the fiber feed control (7). The fibers are then sent to the carding machine (8) which is a typical apparatus used in the textile business. A roller type carding machine is preferred which is designed specifically to handle longer staple length fiber, and is capable of homogeneously blending fibers into a web. The roller top card constantly shuffles the fibers within its structure prior to releasing them in web form. The blending is not absolutely homogeneous, but is good or better than most systems.

A multi-layer web is then formed in the carding process, and is lapped into a low-density batting in the cross-lapping machine (9). The lapped web layers are then sent to the drafter (10) where a drafted web is found and the drafted web is sent to the first needle loom (11). The web is needled on one side, is then sent to the second needle loom (13) and from there to a tensioning device and metal detector (14). Before going to the second needle loom (13) the web is measured at 12. The NDC in an on-line basis-weight measuring device. It provides feedback to the operators about weight variations in the web. The NDC is a gamma gauge, on-line density/weight measuring device. The finished fabric is then sent to a winder and slitter take up unit (15) and from there proceeds to the doffing platform (16). From the doffing platform, the product is sent to the unloading conveyor (17). The material produced from the final needle loom (13) is typically greater than 180 inches wide on a continuous basis. As the fabric is rolled up, it is cut with trimming knives to produce two 90 inch width rolls at the user specified lengths.

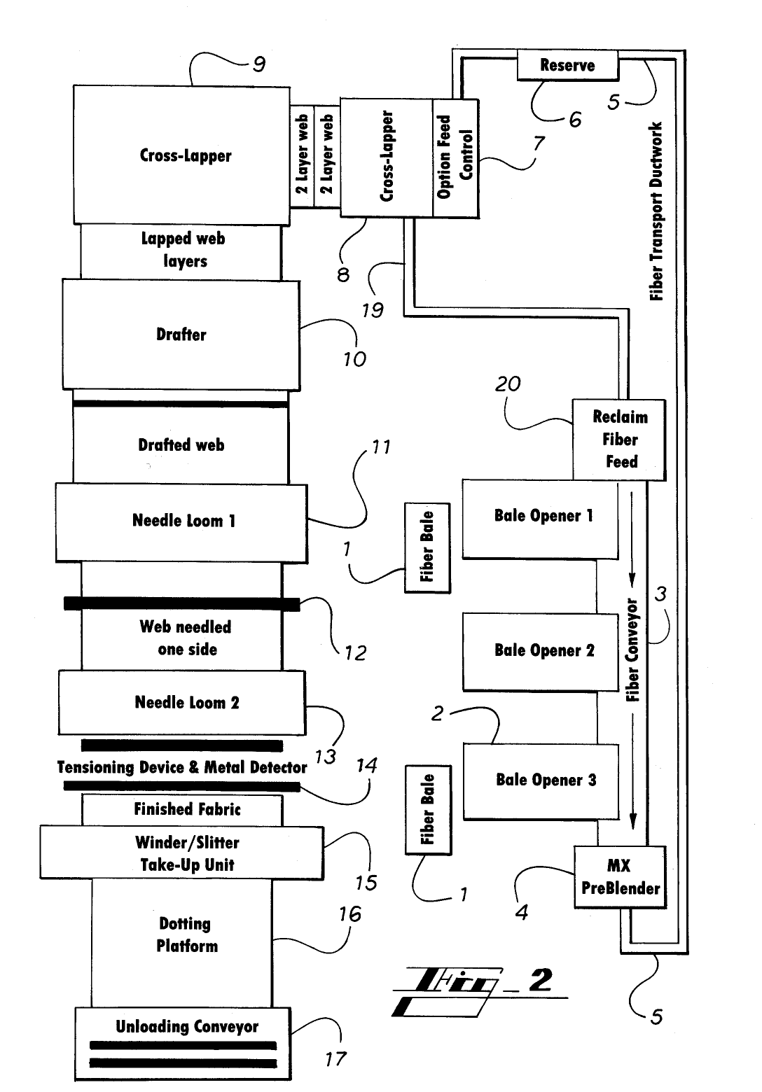

FIG. 2 shows the layered batting as it comes out of the cross lapper (9) prior to being bonded by needling. The un-needled batting is a very low density structure formed of a single continuous fiber web layered back and forth across a moving conveyor perpendicular to the web direction. This is represented in FIG. 2 as “Layer Cross-lapping directions.” As the web sheet is swept back and forth such as brush strokes onto the moving conveyer, it creates an angular orientation of the sheet. This is represented by the shaded and non-shaded sections labeled “Side A of Continuous Sheet” and “Side B of Continuous Sheet.” A number of web layers combined with the conveyor and speed contributes to the weight of the finished product. The folded layers of continuous sheet are shown in FIG. 2.

Once the web layered batting passes through the first of the two needle looms (11), it has been compressed and mechanically bonded to a considerably denser fabric. Prior to this point, the only physical integrity existed as intra-fiber friction. After needling in the needle looms (11) and (13), the fibers are entangled and interlocked with each other. The second needle loom (13) is used to complete the bonding process and to tie down the surface fibers.

The first needle loom (11) needles the batting from the bottom up and the second needle loom (13) needles from the top down, permitting uniform needling on both sides of the material.

The present invention is characterized by the fact that no chemical finish is applied to the fabric and none of the fibers are silica modified.

1. A process for preparing a lightweight fire-retardant fabric comprising:
blending cellulosic fibers with modacrylic fibers wherein the cellulosic fibers have been saturated with a fire-retardant agent to form a blended fiber product;
homogenizing the blended fiber product into a lightweight fiber web,
stacking the lightweight fiber web in a staggered arrangement of layers to form a low density batting,
passing the low density batting through at least one needle-bonding zone which mechanically entangles batting fibers in said low density batting to form a dense fabric,
longitudinally splitting the dense fabric to form two adjacent fabric rolls,
rolling up the split fabric to thereby obtain the lightweight fire-retardant fabric.

2. The method according to claim 1, wherein the blended fiber product has a composition of fibers that is 70 to 90% cellulose and 10 to 30% modacrylic, having a high limited oxygen index.

3. The method of claim 1, wherein the cellulosic fiber is rayon or lyocell saturated with diammonium phosphate.

4. The method according to claim 1, wherein the modacrylic is an acrylic polymer modified with additional monomers which reduce fuel value.

5. A lightweight fabric mechanically bonded through needle punching comprised of fire-retardant fibers wherein the composition of the fibers is 70 to 90% fire-retardant cellulose or lyocell and the remaining 10 to 30% fibers are fire inhibiting modacrylic.

6. The product according to claim 5, wherein the cellulosic fiber has been saturated with diammonium phosphate.

7. The product according to claim 5, wherein the fibers have been formed into a lightweight fiber web in staggered layers to form a low density batting.

8. The product according to claim 7, wherein the batting has been passed through needle-bonding machines for mechanically entangling the batting fibers to form a dense fabric.
